(19) United States
(12) Patent Application Publication
(10) Pub. No.: US 2008/0288767 A1
(43) Pub. Date: Nov. 20, 2008

(54) Computer system

(75) Inventors: Chin-Yu Wang, Taipei City (TW); Hsien-Shan Wang, Taipei City (TW)

Correspondence Address: BACON & THOMAS, PLLC, 625 SLATERS LANE, FOURTH FLOOR, ALEXANDRIA, VA, 22314-1176, US

(73) Assignee: ASUSTEK COMPUTER INC., Taipei City (TW)

(21) Appl. No.: 12/149,308

(22) Filed: Apr. 30, 2008

(30) Foreign Application Priority Data
May 17, 2007 (TW) 096117586

(51) Int. Cl. G06F 9/00

(52) U.S. Cl. 713/2

(57) ABSTRACT

The invention provides a computer system, which includes a motherboard, a nonvolatile memory and a chipset provided on the motherboard. The nonvolatile memory stores a first BIOS and a second BIOS. The chipset has an external flag having a first state and a second state corresponding to the first BIOS and second BIOS, respectively. When the external flag is in the first state, the motherboard is booted by the first BIOS. When the external flag is in the second state, the motherboard is booted by the second BIOS. When one BIOS is booted according to the state of the external flag, if the BIOS is damaged, the other complete BIOS is booted and is used to update the damaged BIOS program.

### BACKGROUND OF THE INVENTION

1. Field of the Invention

The invention relates to a BIOS technology of a computer device and, more particularly, to a computer system with a function of automatically restoring, backuping and updating a BIOS.

2. Description of the Related Art

A basic input output system (BIOS) is the basic software program code loaded into a computer hardware system. The main function of the BIOS includes the power on self test (POST), initializing the memory, motherboard chipset, graphic card and peripheral devices, providing basic settings for the display, keyboard, processor, memory and other components, providing interruption resident program for the operating system or the application program call and loading the operating system, and so on. Therefore, the BIOS can be regarded as a core small operating system communicating with the hardware, and it is usually written by the assembly language.

FIG. 1 shows the content of a BIOS. The BIOS includes a program area, a data area and a booting area. The program area is a BIOS image including BIOS program codes. The data area includes a non-volatile random access memory (NVRAM) area and a system management BIOS (SMBIOS) area for storing system configuration data, serial numbers and needed data for restoring. The booting area is a boot block.

With the change of a computer, a BIOS also needs updating. In the conventional method for updating the BIOS image, if the updating fails, the computer only can be booted in the boot block. However, the capacity of the boot block is limited, so that it only can support the initialization of specific devices in the computer. Therefore, new program and BIOS image should be reloaded via a floppy disk drive or an optical disk drive, and the BIOS image should be re-recorded to the flash memory. This causes unnecessary waste of time.

To solve the above problem, in a conventional method, an extra nonvolatile memory and an extra determining circuit are provided to enable the computer to have more than two BIOS images including a main BIOS image and a backup BIOS image. The version of main BIOS image is the same with that of the backup BIOS image. When the main BIOS image is updated, if the updating succeeds, the new version of the BIOS image cannot be backuped to the backup BIOS image until the operating system is entered. This causes the waste of time. If the updating fails, the circuit is used to switch to the backup BIOS image to restart the operating system. This increases the cost of the motherboard, and the room of the motherboard is increased because of the added circuit.

### BRIEF SUMMARY OF THE INVENTION

The objective of the invention is to provide a computer system with a function of automatically restoring, backuping and updating a BIOS to solve the problem of the conventional technology.

To achieve the above objective, the computer system with a function of automatically, restoring, backuping and updating a BIOS of the invention includes a motherboard, a nonvolatile memory and a chipset. The nonvolatile memory is disposed on the motherboard and used for storing a first BIOS and a second BIOS. Each BIOS has a BIOS image, a NVRAM area, a SMBIOS area and a boot block. The chipset is disposed on the motherboard. The chipset has an external flag having a first state and a second state corresponding to the first BIOS and the second BIOS, respectively. When the external flag is in the first state, the motherboard is booted by the BIOS image of the first BIOS. When the external flag is in the second state, the motherboard is booted by the BIOS image of the second BIOS. When the BIOS image of one BIOS is started according to the state of the external flag, if the BIOS image is damaged, the other complete BIOS image is started and is used to update the damaged BIOS image.

With the function of restoring, backuping and updating BIOS provided in the invention, when a BIOS is damaged, it can be updated automatically, and a user does not need to update the damaged BIOS program manually after the operating system is entered.

### BRIEF DESCRIPTION OF THE DRAWINGS

FIG. 1 is a schematic diagram showing the content of a conventional BIOS.

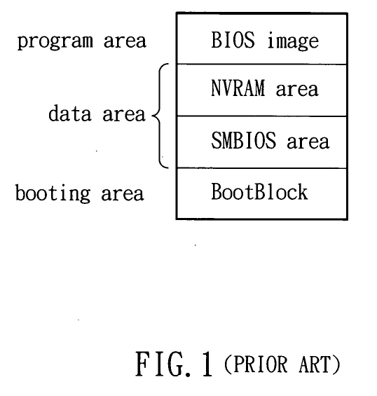

FIG. 2 is schematic diagram showing a computer system according to a preferred embodiment of the invention.

FIG. 3 shows a flow chart of restoring the data area of a BIOS according to a preferred embodiment of the invention.

FIG. 4 shows a flow chart of updating the program area of a BIOS according to a preferred embodiment of the invention.

FIG. 5 shows a flow chart of restoring a damaged BIOS via POST according to a preferred embodiment of the invention.

FIG. 6 shows a flow chart of backuping the data area of a BIOS according to a preferred embodiment of the invention.

### DETAILED DESCRIPTION OF THE EMBODIMENTS

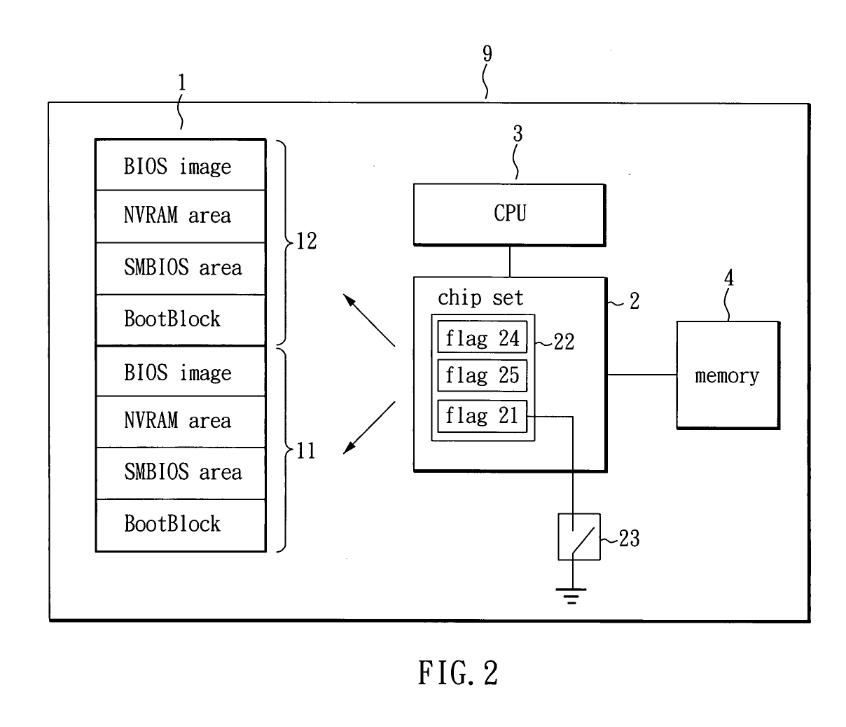

FIG. 2 is a schematic diagram showing a computer system according to a preferred embodiment of the invention.

As shown in FIG. 2, the computer system includes a motherboard 9, a nonvolatile memory 1, a chipset 2, a central processing unit (CPU) 3 and a memory 4. The chipset 2 and the nonvolatile memory 1 are both disposed on the motherboard 9. The function of the chipset 2 is enabling the CPU 3 of the computer system to communicate with other peripheral components. The nonvolatile memory 1 stores the BIOS of the computer system. The memory 4 stores data and various program executed by the CPU 3, wherein the program includes BIOS restoring, backuping and updating programs and so on.

The nonvolatile memory 1 of the embodiment is a flash memory. Certainly, it also may be an electronically erasable programmable read only memory (EEPROM). The flash memory can store a first BIOS 11 and a second BIOS 12. In the embodiment, the first BIOS 11 is used for common booting and the second BIOS 12 is a backup BIOS. Each of the BIOS 11 and the BIOS 12 has a same program area, data area and booting area. The program area is a BIOS image. The data area includes a NVRAM area and a SMBIOS area. The booting area is a boot block including an examining BIOS program for determining whether the BIOS image is damaged.

As people familiar with computer skills knows, the chipset 2 includes a super input output (super 10), a digital signal processor (DSP) and a memory 22 (such as a CMOS RAM) powered by a battery. In the invention, an external flag 21 is provided in the memory 22 powered by the battery. The external flag 21 has a first state (such as “0”) and a second state (such as “1”) corresponding to the first BIOS 11 and the second BIOS 12, respectively.

The external flag 21 is predetermined to be in a first state. A BIOS setup program or an external switch 23 can be used to selectively make the external flag 21 in the first state or in the second state. When the external flag 21 is in the first state, the motherboard 9 is booted by the BIOS image of the first BIOS 11. When the external flag 21 is in the second state, the motherboard 9 is booted by the BIOS image of the second BIOS 12. In addition, in the embodiment, a first BIOS image failure flag 24 and a second BIOS image failure flag 25 are provided in the memory 22 powered by the battery, and they instruct whether the BIOS image of the first BIOS 11 are damaged and whether the BIOS image of the second BIOS 12 are damaged, respectively. The first BIOS image failure flag 24 and the second BIOS image failure flag 25 also can be set in the NVRAM area of the BIOS.

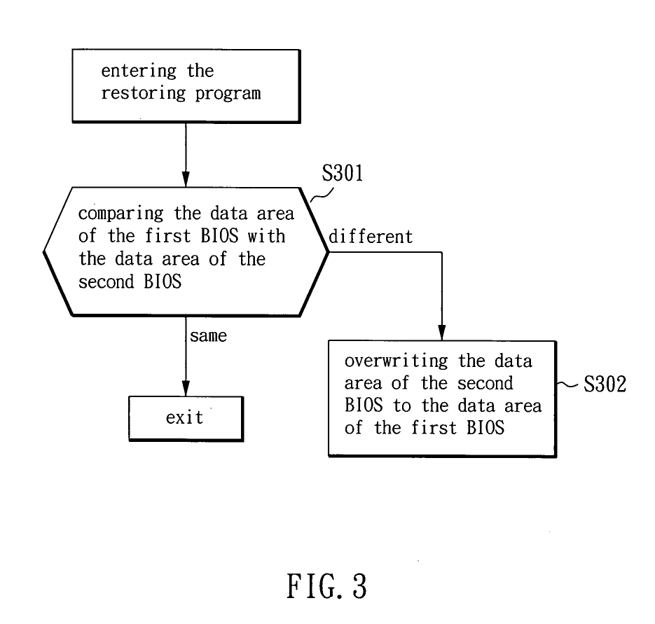

The computer system of the embodiment can restore the damaged data area of a BIOS. For example, when the first BIOS 11 is updated, the power fails, which may cause the data area to be damaged. FIG. 3 shows the flow chart of restoring the data area of a BIOS. The data area of the first BIOS 11 is compared with the data area of the second BIOS 12 (the step S301). If two data areas are the same, it means that the data area is not damaged and does not need to be restored. If two data areas are different, it means that the data area of the first BIOS 11 is damaged, and then the data area of the second BIOS 12 is overwritten to the data area of the first BIOS 11 (the step S302), and the data area of the first BIOS 11 is restored.

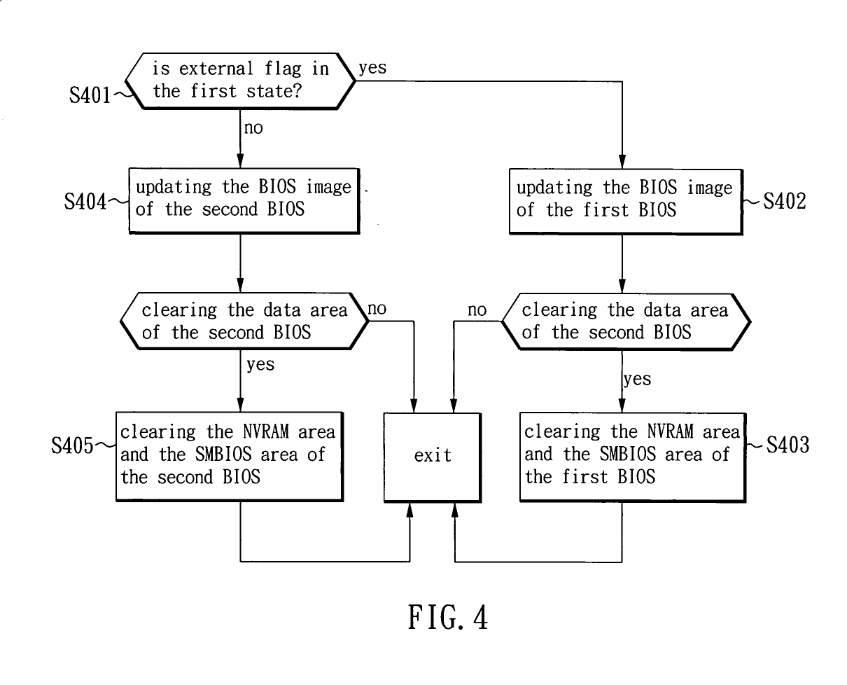

In the embodiment, the computer system can update the program area of the BIOS. For example, a new BIOS is used to update the original BIOS. FIG. 4 shows a flow chart of updating the program area of a BIOS. The state of the external flag 21 is determined first (the step S401). When the external flag 21 is in the first state, the new BIOS image is overwritten to the BIOS image of the first BIOS 11 (the step S402), wherein the new BIOS image can be loaded by a specific device such as an external floppy disk drive, an optical disk drive or a USB device and so on. Then, whether to clear the data area of the first BIOS 11 is determined. If the data area of the first BIOS needs to be cleared, the NVRAM area and the SMBIOS of the first BIOS 11 area are cleared (the step S403). When the external flag 21 is in the second state, the new BIOS image is overwritten to the BIOS image of the second BIOS 11 (the step S404). Then, whether to clear the data area of the second BIOS 12 is determined. If the data area of the second BIOS 12 needs to be cleared, the NVRAM area and the SMBIOS area of the second BIOS 12 are cleared (the step S405). Then, the BIOS finishes updating.

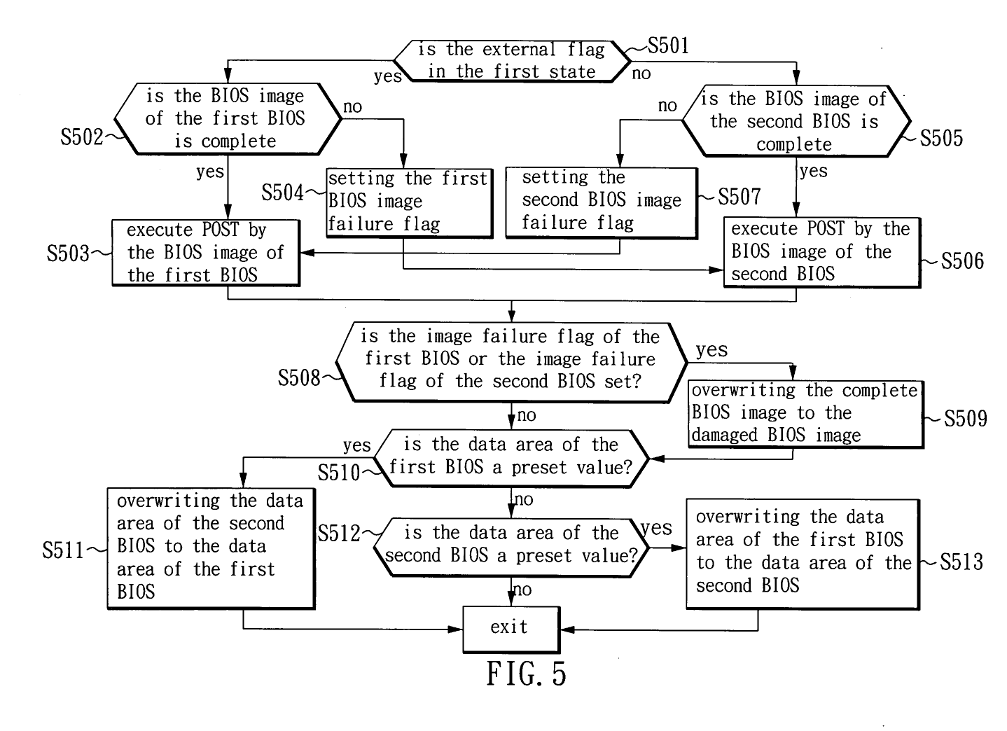

In the embodiment the computer system can automatically restore the damaged BIOS when the power is on. FIG. 5 is a flow chart of restoring the damaged BIOS in POST. First, the state of the external flag 21 is determined (the step S501). When the external flag 21 is in a first state, it means that the motherboard is booted by the first BIOS 11, and the boot block of the first BIOS 11 examines whether the BIOS image thereof is complete (the step S502). If the BIOS image of the first BIOS 11 is complete, it is used to execute the POST (the step S503). If the BIOS image of the first BIOS 11 is not complete, the first BIOS image failure flag 24 is set (the step S504), and the BIOS image of the second BIOS 12 is used to execute the POST (the step S506). If the external flag 21 is in the second state, it means that the motherboard is booted by the second BIOS 12, and then the boot block of the second BIOS 12 examines whether the BIOS image thereof is complete (the step S505). If the BIOS image of the second BIOS 12 is complete, it is used to execute the POST (the step S506). If the BIOS image of the second BIOS 12 is not complete, the second BIOS image failure flag 25 is set (the step S507), and then the BIOS image of the first BIOS 11 is used to execute the POST (the step S503).

After the POST is executed, whether the first BIOS image failure flag 24 or the second BIOS image failure flag 25 is set is examined (the step S508). If one of them is set, it means that one BIOS image is damaged, and the other complete BIOS image is written to the damaged BIOS image (the step S509).

In the step S510, whether the SMBIOS area and the NVRAM area of the first BIOS 11 are predetermined values is examined (the step S510). If they are the predetermined values, it means that the setting values are lost because of the damage of the BIOS, the SMBIOS area and the NVRAM area of the second BIOS 12 are overwritten to the SMBIOS area and the NVRAM area of the first BIOS 11 (the step S511) to restore the data area of the first BIOS 11. If the SMBIOS area and the NVRAM area of the first BIOS 11 are not predetermined values, whether the SMBIOS area and the NVRAM area of the second BIOS 12 are predetermined values is determined (the step S512). If they are predetermined values, it means that the setting values are lost because of the damage of the BIOS, and then the SMBIOS area and the NVRAM area of the first BIOS 11 are overwritten to the SMBIOS area and the NVRAM area of the second BIOS 12 (the step S513) to backup the data area of the first BIOS 11 to the data area of the second BIOS 12.

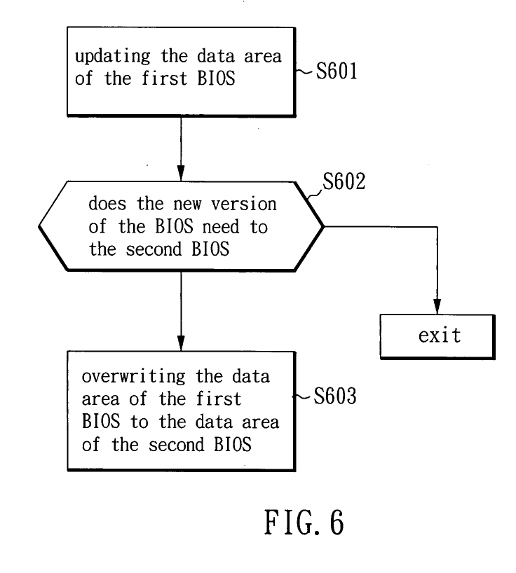

The computer system can backup the data area of a BIOS. FIG. 6 shows a flow chart of backuping the data area of the BIOS. After the data area of the first BIOS 11 is updated (the step S601), if the new data area needs to be backuped to the second BIOS 12 (the step S602), the SMBIOS area and the NVRAM area of the first BIOS 11 are overwritten to the SMBIOS area and the NVRAM area of the second BIOS 12 (the step S603) and are backuped.

From the above, the embodiment of the invention provides the function of restoring, backuping and updating a BIOS. When a BIOS is damaged, the damaged BIOS can be updated automatically, and a user does not need to update the damaged BIOS program manually after the operating system is entered.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer system comprising:
a motherboard;
a nonvolatile memory disposed on the motherboard and used for storing a first BIOS and a second BIOS, wherein each of the first BIOS and the second BIOS has a BIOS image, a non-volatile random access memory (NVRAM) area, a system management BIOS (SMBIOS) and a boot block; and
a chipset disposed on the motherboard and having an external flag having a first state and a second state corresponding to the first BIOS and the second BIOS, respectively, wherein when the external flag is in the first state, the motherboard is booted by the BIOS image of the first BIOS, and when the external flag is in the second state, the motherboard is booted by the BIOS image of the second BIOS
wherein when the BIOS image of one of the first BIOS and the second BIOS is started according to the state of the external flag, if the BIOS image is damaged, the other complete BIOS image is started and is used to update the damaged BIOS image.

2. The computer system according to claim 1, wherein whether the BIOS image is damaged is examined by the boot block.

3. The computer system according to claim 2, wherein after a BIOS image is started, whether the SMBIOS area and the NVRAM area of the first BIOS are predetermined values is examined, and if they are predetermined values, the SMBIOS area and the NVRAM area of the second BIOS are overwritten to the SMBIOS area and the NVRAM area of the first BIOS.

4. The computer system according to claim 2, wherein after a BIOS image is started, whether the SMBIOS area and the NVRAM area of the second BIOS are predetermined values is examined, and if they are predetermined values, the SMBIOS area and the NVRAM area of the first BIOS are overwritten to the SMBIOS area and the NVRAM area of the second BIOS.

5. The computer system according to claim 1, wherein when the NVRAM area and the SMBIOS area of the first BIOS are determined to be different from the NVRAM area and the SMBIOS area of the second BIOS after the NVRAM area and the SMBIOS area of the first BIOS are compared with the NVRAM area and the SMBIOS area of the second BIOS, the NVRAM area and the SMBIOS area of the second BIOS are written to the NVRAM area and the SMBIOS area of the first BIOS.

6. The computer system according to claim 1, wherein when the BIOS is updated, if the external flag is in the first state, a new BIOS image is written to the BIOS image of the first BIOS, and the NVRAM area and the SMBIOS area of the first BIOS are cleared selectively; when the external flag is in the second state, the new BIOS image is overwritten to the BIOS image of the second BIOS, and the NVRAM area and the SMBIOS area of the second BIOS are cleared selectively.

7. The computer system according to claim 1, wherein when the BIOS is backuped, the SMBIOS area and the NVRAM area of the first BIOS are overwritten to the SMBIOS area and the NVRAM area of the second BIOS.

8. The computer system according to claim 1, wherein the nonvolatile memory is a flash memory or an electronically erasable programmable read only memory (EEPROM).

9. The computer system according to claim 1, wherein the boot block comprises an examining BIOS program for determining whether the BIOS image is damaged.

10. The computer system according to claim 1, wherein the chipset comprises a memory powered by a battery, and the external flag is provided by the memory powered by the battery.

11. The computer system according to claim 1, wherein a BIOS setup program is used to selectively enable the external flag to be in the first state or in the second state.

12. The computer system according to claim 10, wherein an external switch is used to selectively enable the external flag to be in the first state or the second state.
